(19) United States
(12) Patent Application Publication
(10) Pub. No.: US 2018/0231009 A1
(43) Pub. Date: Aug. 16, 2018

(54) THIN FAN AND THIN-PLATE MOTOR

(71) Applicant: DELTA ELECTRONICS, INC., Taoyuan City (TW)

(72) Inventors: Cheng-Hsien YEH, Taoyuan City (TW); Chih-Wei CHAN, Taoyuan City (TW)

(21) Appl. No.: 15/859,109

(22) Filed: Dec. 29, 2017

Related U.S. Application Data
(60) Provisional application No. 62/458,688, filed on Feb. 14, 2017.

(30) Foreign Application Priority Data
Jun. 26, 2017 (CN) 201710494155.9

(51) Int. Cl. F04D 25/08; H02K 5/16; F04D 29/054; F04D 29/056; F04D 29/62; H02K 5/18; H02K 9/06

(52) U.S. Cl. CPC F04D 25/08; H02K 5/165; F04D 29/054; H02K 9/06; F04D 29/626; H02K 5/18; F04D 29/056

(57) ABSTRACT

A thin fan includes a frame and a driving device disposed in the frame. The driving device includes a stator structure and a rotor structure. The stator structure includes a stator pole group and a base body connected to the frame. The stator pole group is disposed on the outer periphery of the base body. The rotor structure is disposed corresponding to the stator structure, and includes a rotor shell, a magnetic structure and an impeller connected to the rotor shell. The center of the rotor shell is formed with a cylindrical shaft, which deeply penetrates into the base body. The rotor shell and the shaft are a single component manufactured by processing a single material workpiece. The magnetic structure is disposed on the inner wall of the rotor shell, and the stator magnetic pole group magnetically drives the magnetic structure as well as the rotor shell to rotate.

### CROSS REFERENCE TO RELATED APPLICATIONS

The non-provisional patent application claims priority to U.S. provisional patent application with Ser. No. 62/458,688 filed on Feb. 14, 2017. This and all other extrinsic materials discussed herein are incorporated by reference in their entirety.

This Non-provisional application claims priority under 35 U.S.C. § 119(a) on Patent Application No(s). 201710494155.9 filed in People's Republic of China on Jun. 26, 2017, the entire contents of which are hereby incorporated by reference.

### BACKGROUND OF THE INVENTION

### Field of Invention

The present disclosure relates to a thin fan and a thin-plate motor that have an integrally formed rotor shell and shaft.

### Related Art

In the existing electronic device, the heat dissipation efficiency is one of the major factors to determine the performance and lifetime of the electronic device. In general, the electronic device is provided with a fan for dissipating the generated heat. In more detailed, the fan can generate an airflow to increase the heat dissipation efficiency. Since the fan can provide an outstanding heat dissipation efficiency, it is generally applied to various electronic devices.

In order to fit the compact size of various electronic devices, the fan structure or motor is also designed thinner. In the conventional thin fan or thin-plate motor, the rotor shell and shaft of the rotor structure are connected by laser welding due to the limitation of the thickness of the rotor shell. However, the laser welding may cause the unstable of the manufacturing process of the rotor shell, the oil leaking of the rotor shell, the unstable rotation of the rotor structure, and the poor vibration duration.

The above-mentioned connection method and structure are disclosed in U.S. Pat. No. 8,888,450B2 and U.S. Patent Application No. US20080187257A1. Since the rotor shell and the shaft are individual parts, the connection thereof will have the above mentioned problems. Besides, the thickness of the rotor shell has limitation, the size of the fan or motor cannot be thinner.

In U.S. Pat. No. 7,021,829B, the rotor shell and the shaft are integrally formed as a single piece by the stamping or casting process. However, the rotor shell made by the stamping process may have assembling error and unstable rotation due to the processing tolerances on, for example, the flatness of the magnetic surface, the accuracy of the inner diameter of the rotor shell, and the draft angle. In particular, the gaps between the components of the ultra-thin fan or ultra-thin-plate motor are very small. Any of the above processing tolerances will cause a very serious interference in the rotation of the rotor structure, and will sufficiently increase the difficulty in the following manufacturing processes and assembling.

Therefore, it is an important subject to improve the stability of the manufacturing process of the rotor structure, increase the accuracy of manufacturing and assembling processes, reducing the assembling processes of the components, and enhance the operation efficiency of the thin fan and thin-plate motor.

### SUMMARY OF THE INVENTION

In view of the foregoing, the present disclosure provides a thin fan, which includes a frame and a driving device disposed in the frame. The driving device includes a stator structure and a rotor structure. The stator structure includes a stator pole group and a base body. The base body is connected to the frame, and the stator pole group is disposed on an outer periphery of the base body. The rotor structure is disposed corresponding to the stator structure. The rotor structure includes a rotor shell, a magnetic structure, and an impeller. The center of the rotor shell is formed with a cylindrical shaft, and the shaft penetrates into the base body. The rotor shell and the shaft are a single component manufactured by processing a single material workpiece. The magnetic structure is disposed on an inner wall of the rotor shell. The stator magnetic pole group magnetically drives the magnetic structure as well as the rotor shell to rotate. The impeller is connected to the rotor shell.

In one embodiment, a maximum height of the frame is not greater than 5 mm.

In one embodiment, the single material workpiece is a metal material or an alloy material, and the rotor shell and the shaft are manufactured by one turning process or one molding process.

In one embodiment, the rotor shell further includes an oil seal disposed on the rotor shell and surrounding a periphery of the shaft, and the oil seal is located corresponding to the base body.

In one embodiment, the rotor shell further includes a protruding structure disposed on a surface of the rotor shell away from the shaft. The protruding structure is located corresponding to the shaft. The protruding structure, the rotor shell and the shaft are a single component manufactured by processing a single material workpiece.

In one embodiment, the protruding structure is a cylindrical structure, an arc structure, a hemispherical structure, or a cone structure.

In one embodiment, a surface of the shaft is configured with a plurality of groove structures, and the groove structures are annular grooves, oblique grooves, V-shaped grooves, or U-shaped grooves.

In one embodiment, a surface of the rotor shell facing the stator structure and corresponding to the base body is configured with a plurality of dynamic patterns or thrust patterns.

In one embodiment, a surface of the rotor shell facing the stator structure and corresponding to the base body is formed with an oil repellent layer.

The present disclosure further provides a thin-plate motor including a motor shell and a driving device. The driving device is disposed in the motor shell and includes a stator structure and a rotor structure. The stator structure includes a stator pole group and a base body. The base body is connected to the motor shell, and the stator pole group is disposed on an outer periphery of the base body. The rotor structure is disposed corresponding to the stator structure and includes a rotor shell and a magnetic structure. The center of the rotor shell is formed with a cylindrical shaft. One end of the shaft penetrates into the base body. The rotor shell and the shaft are a single component manufactured by processing a single material workpiece. The magnetic structure is disposed on an inner wall of the rotor shell. The stator magnetic pole group magnetically drives the magnetic structure as well as the rotor shell to rotate.

In one embodiment, a maximum height of the motor shell is not greater than 5 mm.

In one embodiment, the single material workpiece is a metal material or an alloy material, and the rotor shell and the shaft are manufactured by one turning process or one molding process.

In one embodiment, the rotor shell further includes an oil seal disposed on the rotor shell and surrounding a periphery of the shaft, and the oil seal is located corresponding to the base body.

In one embodiment, a surface of the shaft is configured with a plurality of groove structures, and the groove structures are annular grooves, oblique grooves, V-shaped grooves, or U-shaped grooves.

In one embodiment, a surface of the rotor shell facing the stator structure and corresponding to the base body is configured with a plurality of dynamic patterns or thrust patterns.

In one embodiment, a surface of the rotor shell facing the stator structure and corresponding to the base body is formed with an oil repellent layer.

As mentioned above, the rotor shell and the shaft of the thin fan and thin-plate motor of the disclosure are a single component manufactured by processing a single material workpiece. Accordingly, the rotor shell and the shaft can be an integrated seamless single component, so that the assembling accuracy, flatness and manufacturing yield of the entire assembly can be improved. This configuration can increase the entire manufacturing stability, and the laser welding process is not needed. Thus, the processes and costs for manufacturing the thin fan or thin-plate motor can be reduced.

An additional turning process is performed to form a plurality of groove structures, dynamic patterns or thrust patterns on the surface of the rotor structure. Besides, an oil repellent layer is formed on the surface of the rotor shell so as to provide the thin fan and thin-plate motor with the ability of preventing oil leakage. This configuration can further improve the operation efficiency and lifetime of the thin fan and thin-plate motor.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a schematic diagram showing a thin fan according to an embodiment of the disclosure;

FIG. 1B is an exploded view of the thin fan of FIG. 1A;

FIG. 1C is a sectional view of the thin fan of FIG. 1A along the line A-A;

FIGS. 2A to 2D are schematic diagram showing different aspects of the protruding structures;

FIGS. 3A to 3D are schematic diagram showing different aspects of the groove structures;

FIG. 4A is a schematic diagram showing a thin-plate motor according to an embodiment of the disclosure; and

FIG. 4B is a sectional view of the thin fan of FIG. 4A along the line C-C.

### DETAILED DESCRIPTION OF THE INVENTION

The present invention will be apparent from the following detailed description, which proceeds with reference to the accompanying drawings, wherein the same references relate to the same elements.

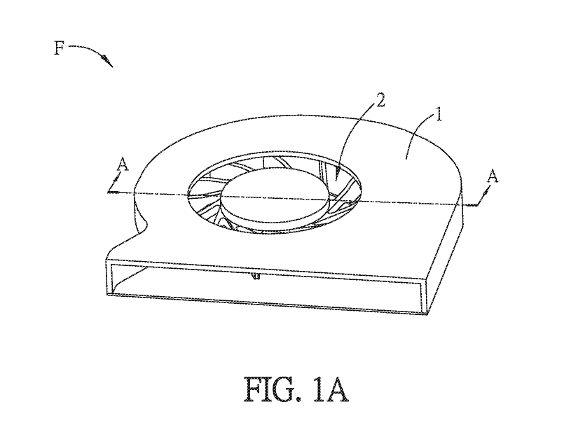

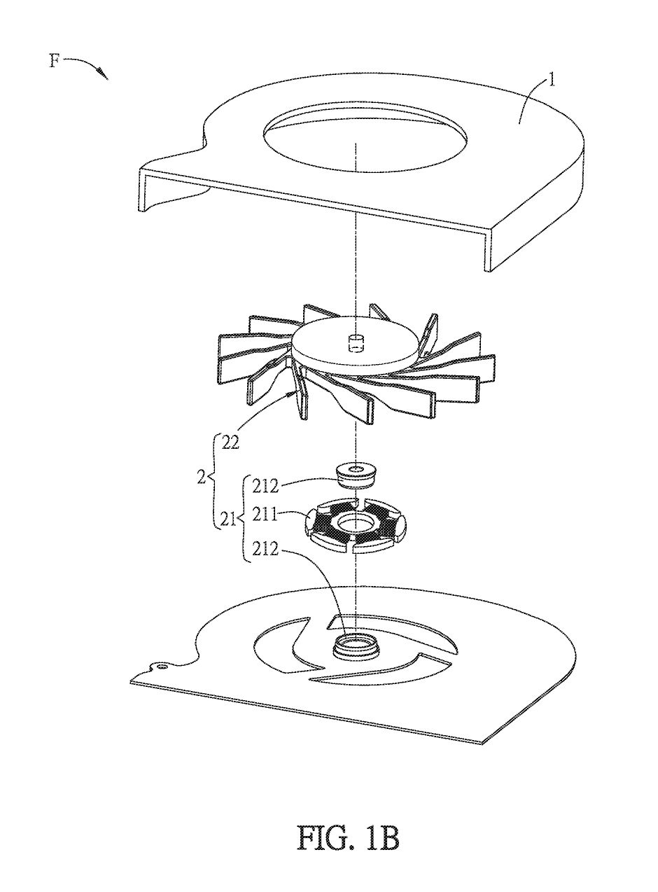

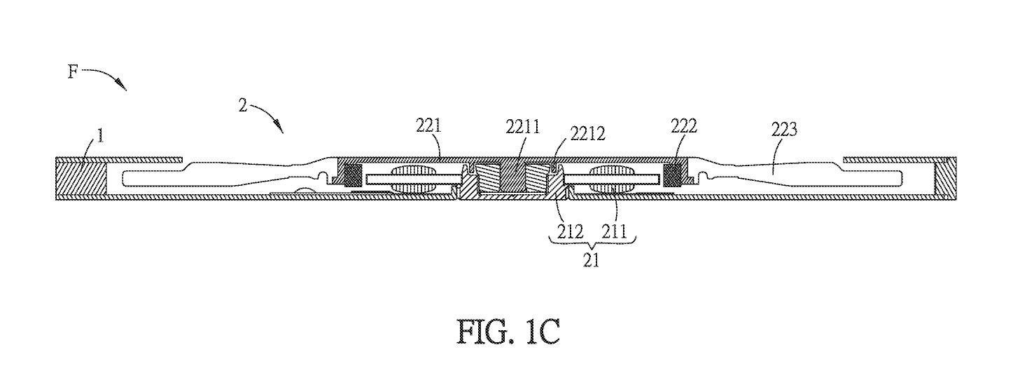

FIG. 1A is a schematic diagram showing a thin fan according to an embodiment of the disclosure, FIG. 1B is an exploded view of the thin fan of FIG. 1A, and FIG. 1C is a sectional view of the thin fan of FIG. 1A along the line A-A.

As shown in FIGS. 1A to 1C, the present disclosure provides a thin fan F, which includes a frame 1 and a driving device 2 disposed in the frame 1. The driving device 2 includes a stator structure 21 and a rotor structure 22. The stator structure 21 includes a stator pole group 211 and a base body 212. The base body 212 is connected to the frame 1, and the stator pole group 211 is disposed on an outer periphery of the base body 212. The rotor structure 22 is disposed corresponding to the stator structure 21. The rotor structure 22 includes a rotor shell 221, a magnetic structure 222, and an impeller 223. The center of the rotor shell 221 is formed with a cylindrical shaft 2211, and the shaft penetrates into the base body 212. The base body 212 can be a bearing and/or a bushing. The rotor shell 221 and the shaft 222 are a single component manufactured by processing a single material workpiece. The magnetic structure 222 is disposed on an inner wall of the rotor shell 221. The stator magnetic pole group 211 magnetically drives the magnetic structure 222 as well as the rotor shell 221 to rotate. The impeller 223 is connected to the rotor shell 221.

In this embodiment, the rotor shell 221 and the shaft 2211 are made of the same metal material or alloy material, and the rotor shell 221 and the shaft 2211 are manufactured by one turning process or one molding process instead of assembling, welding, adhering, or locking. The rotor shell 221 and the shaft 2211 of this embodiment are a seamless and integrated single component. Accordingly, this configuration can satisfy the required rigidity condition of the rotor structure 22, and the metal rotor shell 221 can achieve a thinner design for sufficiently reducing the height of the frame 1. In this embodiment, the maximum height of the frame 1 is not greater than 5 mm. In some embodiments, the maximum height of the frame 1 is 2.5 mm. Accordingly, the thin fan F can be further thinned.

In the thin fan of the disclosure, the rotor shell and the shaft can be manufactured by CNC (Computer Numerical Control) machining or molding to form a seamless and integrated single component. Herein, the rotor structure can be processed by a single machining to achieve the desired accuracy and flatness, so the material for manufacturing the shaft can be reduced so as to decrease the manufacturing cost. Moreover, this process can eliminate the possible breaks and poor flatness of the rotor shell caused by the conventional laser welding process and stamping process. In other words, this disclosure can improve the entire process stability and manufacturing yield, and simplify the assembling process of the thin fan.

As mentioned above, the rotor shell 221 further includes an oil seal 2212 disposed on the rotor shell 221 and surrounding a periphery of the shaft 2211, and the oil seal 2212 is located corresponding to the base body 212. The base body 212 can be a bearing and/or a bushing, and the oil seal 2212 can be disposed outside the bearing, inside the bushing, or deeply into the space between the bearing and the bushing. Furthermore, due to the single process property of the CNC machining or molding, the rotor shell 221 and the shaft 2211 can be manufactured as a seamless integrated single component, and the configuration of the oil seal 2212 can further enhance the ability of preventing oil leakage of the thin fan F. This can increase the lifetime of the thin fan F, reduce the occupied space of the components, and sufficiently minimize the size of the thin fan F.

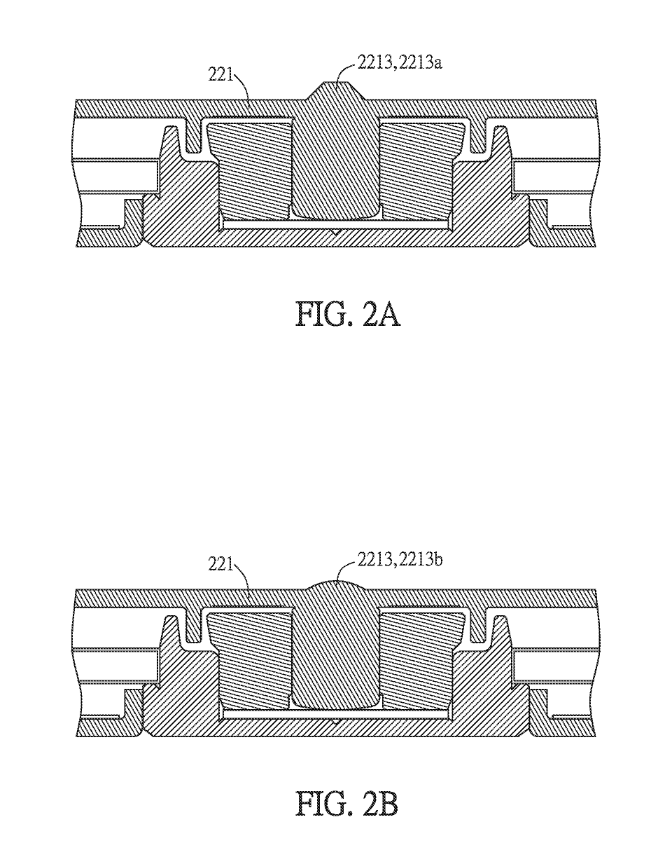

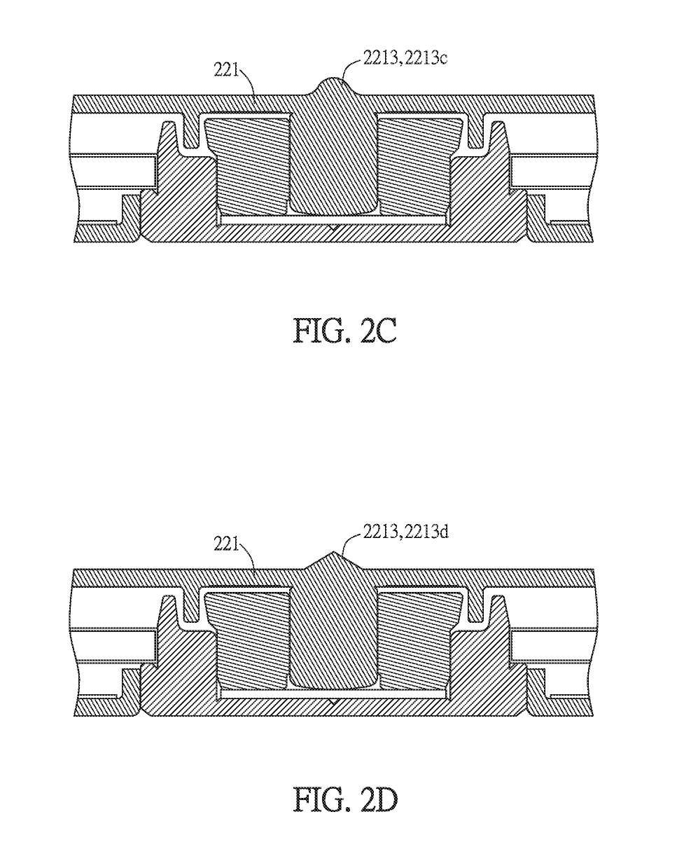

Referring to FIGS. 2A to 2D, in the thin fan F of this disclosure, the rotor shell 221 further includes a protruding structure 2213 for reducing the collisions between the rotor structure 22 and the external system. The protruding structure 2213 is disposed on a surface of the rotor shell 221 away from the shaft 2211. The protruding structure 2213 is located corresponding to the shaft 2211. The protruding structure 2213, the rotor shell 221 and the shaft 2211 are a single component manufactured by processing a single material workpiece. In this embodiment, the protruding structure can be a cylindrical structure 2213a (see FIG. 2A), an arc structure 2213b (see FIG. 2B), a hemispherical structure 2213c (see FIG. 2C), or a cone structure 2213d (see FIG. 2D). Furthermore, due to the single process property of the CNC machining or molding, the protruding structure 2213, the rotor shell 221 and the shaft 2211 can be manufactured as a seamless integrated single component. During the operation of the rotor structure 22, the configuration of the protruding structure 2213 can reduce the collision friction between the rotor structure 22 and the external system, decrease the noise of the thin fan F when applying an external force, and increase the lifetime of the thin fan F. In addition, when the protruding structure 2213 and the shaft 2211 are coaxial, the maximum effect of reducing the friction can be obtained.

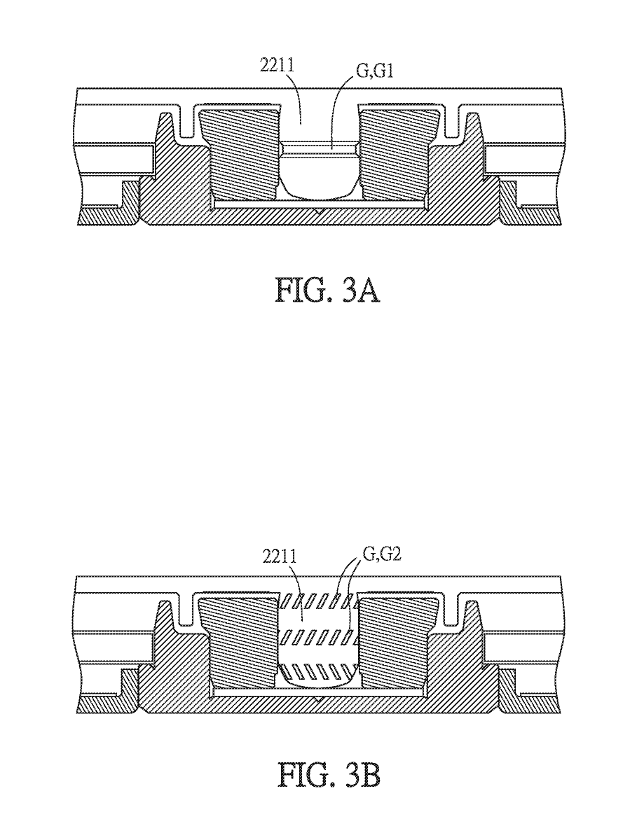

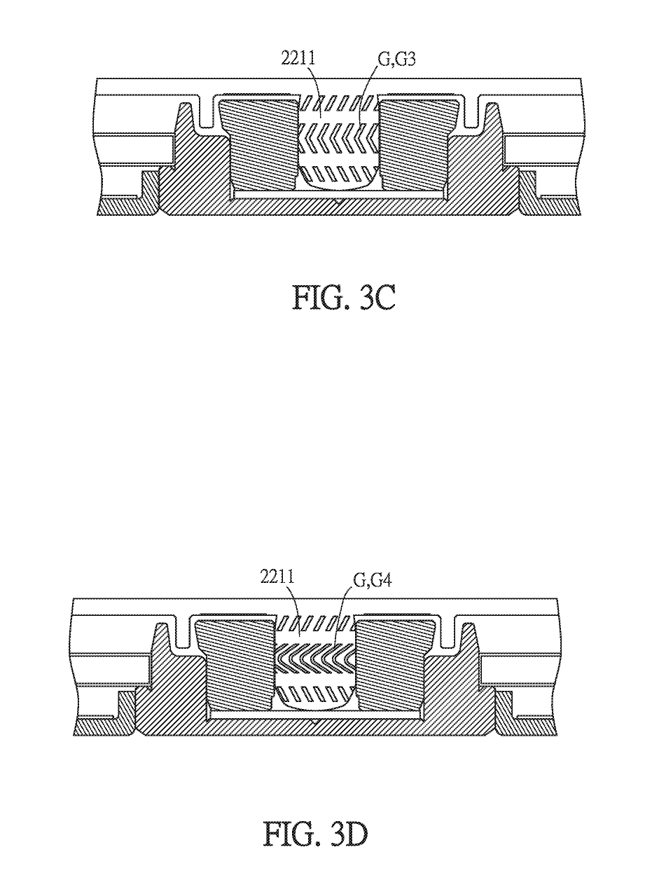

Referring to FIGS. 3A to 3D, in this embodiment, the thin fan F can be processed by CNC machining to form a plurality of groove structures G on the surface of the shaft 2211. Herein, the groove structures G can be annular grooves G1 (see FIG. 3A), oblique grooves G2 (see FIG. 3B), V-shaped grooves G3 (see FIG. 3C), or U-shaped grooves G4 (see FIG. 3D). The configuration of the groove structures G can increase the axial supporting ability of the shaft 2211 so as to enhance the operation stability of the rotor structure 22 and increase the lifetime of the thin fan F.

In addition, the surface of the rotor shell 221 facing the stator structure 21 and corresponding to the base body 212 is configured with a plurality of dynamic patterns or thrust patterns (not shown). Moreover, the surface of the rotor shell 221 facing the stator structure 21 and corresponding to the base body 212 is formed with an oil repellent layer (not shown). The configuration of the oil repellent layer in cooperated with the oil seal can enhance the ability of preventing oil leakage of the thin fan F and increase the lifetime of the thin fan F.

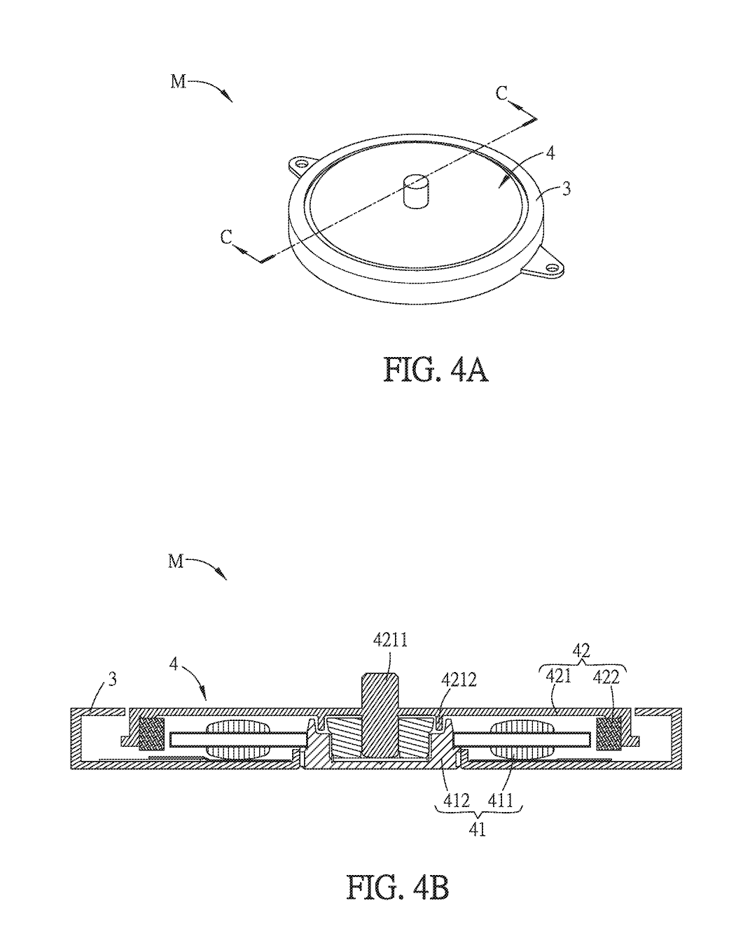

FIG. 4A is a schematic diagram showing a thin-plate motor according to an embodiment of the disclosure, and FIG. 4B is a sectional view of the thin fan of FIG. 4A along the line C-C.

The present disclosure further provides a thin-plate motor M, which includes a motor shell 3 and a driving device 4. The driving device 4 is disposed in the motor shell 3 and includes a stator structure 41 and a rotor structure 42. The stator structure 41 includes a stator pole group 411 and a base body 412. The base body 412 is connected to the motor shell 3, and the stator pole group 411 is disposed on an outer periphery of the base body 412. The rotor structure 42 is disposed corresponding to the stator structure 41 and includes a rotor shell 421 and a magnetic structure 422. The center of the rotor shell 421 is formed with a cylindrical shaft 4211. One end of the shaft 4211 penetrates into the base body 412. The base body 412 can be a bearing and/or a bushing. The rotor shell 421 and the shaft 4211 are a single component manufactured by processing a single material workpiece. The magnetic structure 422 is disposed on an inner wall of the rotor shell 421. The stator magnetic pole group 411 magnetically drives the magnetic structure 422 as well as the rotor shell 421 to rotate.

In this embodiment, the rotor shell 421 and the shaft 4211 are made of the same metal material or alloy material, and the rotor shell 421 and the shaft 4211 are manufactured by one turning process or one molding process instead of assembling, welding, adhering, or locking. The rotor shell 421 and the shaft 4211 of this embodiment are a seamless and integrated single component. Accordingly, this configuration can satisfy the required rigidity condition of the rotor structure 42, and the metal rotor shell 421 can achieve a thinner design for sufficiently reducing the height of the motor shell 3. In this embodiment, the maximum height of the motor shell 3 is not greater than 5 mm. In some embodiments, the maximum height of the motor shell 3 is 2.5 mm. Accordingly, the thin-plate motor M can be further thinned.

In the thin-plate motor of the disclosure, the rotor shell and the shaft can be manufactured by CNC (Computer Numerical Control) machining or molding to form a seamless and integrated single component. Herein, the rotor structure can be processed by a single machining to achieve the desired accuracy and flatness, so the material for manufacturing the shaft can be reduced so as to decrease the manufacturing cost. Moreover, this process can eliminate the possible breaks and poor flatness of the rotor shell caused by the conventional laser welding process and stamping process. In other words, this disclosure can improve the entire process stability and manufacturing yield, and simplify the assembling process of the thin-plate motor.

The other features of the thin-plate motor M of this embodiment (e.g. the oil seal, oil repellent layer, groove structures, dynamic patterns, thrust patterns, and the likes) can be referred to those of the thin fan F, so the detailed descriptions thereof will be omitted.

In summary, the rotor shell and the shaft of the thin fan and thin-plate motor of the disclosure are a single component manufactured by processing a single material workpiece with turning or molding process. Accordingly, the rotor structure can achieve the desired accuracy, flatness and manufacturing yield by a single process. This process can eliminate the possible breaks and poor flatness of the rotor shell caused by the conventional laser welding process and stamping process. In other words, this disclosure can improve the entire process stability, reduce the assembling processes, and decrease the manufacturing and detection costs.

In addition, an additional turning process is performed to form a plurality of groove structures, dynamic patterns or thrust patterns on the surface of the rotor structure. Besides, an oil repellent layer is formed on the surface of the rotor shell so as to provide the thin fan and thin-plate motor with the ability of preventing oil leakage. This configuration can further improve the operation efficiency and lifetime of the thin fan and thin-plate motor.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A thin fan, comprising:
a frame; and
a driving device disposed in the frame, the driving device comprising:
a stator structure comprising a stator pole group and a base body, wherein the base body is connected to the frame, and the stator pole group is disposed on an outer periphery of the base body; and
a rotor structure disposed corresponding to the stator structure, and the rotor structure comprises:
a rotor shell, wherein a center of the rotor shell is formed with a cylindrical shaft, the shaft penetrates into the base body, and the rotor shell and the shaft are a single component manufactured by processing a single material workpiece,
a magnetic structure disposed on an inner wall of the rotor shell, wherein the stator magnetic pole group magnetically drives the magnetic structure as well as the rotor shell to rotate, and
an impeller connected to the rotor shell.

2. The thin fan of claim 1, wherein a maximum height of the frame is not greater than 5 mm.

3. The thin fan of claim 1, wherein the single material workpiece is a metal material or an alloy material, and the rotor shell and the shaft are manufactured by one turning process or one molding process.

4. The thin fan of claim 1, wherein the rotor shell further comprises:
an oil seal disposed on the rotor shell and surrounding a periphery of the shaft, wherein the oil seal is located corresponding to the base body.

5. The thin fan of claim 1, wherein the rotor shell further comprises:
a protruding structure disposed on a surface of the rotor shell away from the shaft, wherein the protruding structure is located corresponding to the shaft, and the protruding structure, the rotor shell and the shaft are a single component manufactured by processing a single material workpiece.

6. The thin fan of claim 5, wherein the protruding structure is a cylindrical structure, an arc structure, a hemispherical structure, or a cone structure.

7. The thin fan of claim 1, wherein a surface of the shaft is configured with a plurality of groove structures, and the groove structures are annular grooves, oblique grooves, V-shaped grooves, or U-shaped grooves.

8. The thin fan of claim 1, wherein a surface of the rotor shell facing the stator structure and corresponding to the base body is configured with a plurality of dynamic patterns or thrust patterns.

9. The thin fan of claim 1, wherein a surface of the rotor shell facing the stator structure and corresponding to the base body is formed with an oil repellent layer.

10. A thin-plate motor, comprising:
a motor shell; and
a driving device disposed in the motor shell, the driving device comprising:
a stator structure comprising a stator pole group and a base body, wherein the base body is connected to the motor shell, and the stator pole group is disposed on an outer periphery of the base body; and
a rotor structure disposed corresponding to the stator structure, wherein the rotor structure comprises:
a rotor shell, wherein a center of the rotor shell is formed with a cylindrical shaft, one end of the shaft penetrates into the base body, and the rotor shell and the shaft are a single component manufactured by processing a single material workpiece, and
a magnetic structure disposed on an inner wall of the rotor shell, wherein the stator magnetic pole group magnetically drives the magnetic structure as well as the rotor shell to rotate.

11. The thin-plate motor of claim 10, wherein a maximum height of the motor shell is not greater than 5 mm.

12. The thin-plate motor of claim 10, wherein the single material workpiece is a metal material or an alloy material, and the rotor shell and the shaft are manufactured by one turning process or one molding process.

13. The thin-plate motor of claim 10, wherein the rotor shell further comprises:
an oil seal disposed on the rotor shell and surrounding a periphery of the shaft, wherein the oil seal is located corresponding to the base body.

14. The thin-plate motor of claim 10, wherein a surface of the shaft is configured with a plurality of groove structures, and the groove structures are annular grooves, oblique grooves, V-shaped grooves, or U-shaped grooves.

15. The thin-plate motor of claim 10, wherein a surface of the rotor shell facing the stator structure and corresponding to the base body is configured with a plurality of dynamic patterns or thrust patterns.

16. The thin-plate motor of claim 10, wherein a surface of the rotor shell facing the stator structure and corresponding to the base body is formed with an oil repellent layer.
